(19) United States
(12) Patent Application Publication
(10) Pub. No.: US 2002/0129174 A1
(43) Pub. Date: Sep. 12, 2002

(54) Apparatus and method for providing a unified messaging integration tool

(76) Inventor: Christopher D. LaBaw, Herndon, VA (US)

Correspondence Address: Christopher D. LaBaw, 12418 Rock Ridge Road, Herndon, VA, 20170, US

(21) Appl. No.: 10/043,889

(22) Filed: Jan. 11, 2002

Related U.S. Application Data
(60) Provisional application No. 60/261,139, filed on Jan. 12, 2001.

(51) Int. Cl. G06F 15/163; G06F 9/54; G06F 9/00

(52) U.S. Cl. 709/310

(57) ABSTRACT

The software tool of the present invention operates on a network connected to plural messaging systems and is a synchronization engine to provide a unified messaging system. It consists of a series of intelligent logic functions and filters. The engine periodically polls the various messaging systems and is able to accept lists of messages from any messaging system (voice, e-mail, fax, or otherwise), correlate changes to the messages based on definable parameters (such as: size, date, type, status), and then replicate and synchronize the messages between all of the messaging systems in appropriate formats. By doing this, each messaging system can contain identical content using the most recent version so that any of the messaging systems can be accessed and the exact same data can be independently accessed and modified. The present invention's logic functions are optimized to eliminate copying of unchanged messages.

### RELATED APPLICATIONS

This application claims priority to Provisional Application Serial No. 60/261,139, filed Jan. 12, 2001, which is hereby incorporated by reference.

### FIELD OF THE INVENTION

The present invention is drawn to a software tool that leverages industry standards in e-mail messaging communication formats, database formats, file storage formats and voice mail formats to provide a solution for integrating disparate messaging systems with each other. Its first application is in the field of Unified Messaging for the purpose of allowing an end-user to access their voice and e-mails through one interface. The interface used by the user for message retrieval is independent of the software tool. Furthermore, the present invention is not limited to Unified Messaging applications.

### BACKGROUND OF THE INVENTION

Messaging, such as e-mail and voice-mail, is becoming increasing prevalent and it has been found desirable to have systems that can handle both. Systems, such as 3Com's NBX phone system can provide voice over IP, but interoperability with existing systems remains a problem.

### BRIEF SUMMARY OF THE INVENTION

At the core, the software tool of the present invention is a synchronization engine consisting of a series of intelligent logic functions and filters. The engine is able to accept lists of messages from any messaging system (voice, e-mail, fax, SMS, IM, pager, or otherwise), correlate changes to the messages based on definable parameters (such as: size, date, type, status), and then replicate and synchronize the messages between all of the messaging systems so that they contain identical content using the most recent version so that any of the messaging systems can be accessed and the exact same data can be independently accessed and modified. The present invention's logic functions are optimized to eliminate copying of unchanged messages. The present invention is designed to be run periodically in a “poll based” method to maintain full synchronization between messaging systems. A typical poll period might be every five minutes but can be set for any interval.

Surrounding the core of the present invention are various connectors that allow the software tool to interface with various messaging systems. The interfaces support connection methods such as, but not limited to: FTP, IMAP, POP3, SMTP, LDAP, Direct File Access, Exchange MAPI, SQL, Oracle, and Serial. Additional connectors can be added as messaging system needs arise. The connectors not only allow interfacing to almost any industry standard messaging system, but the connectors also perform any and all translations necessary to move messages between systems. For example, moving a text-based e-mail message from a traditional e-mail system, through the core, and then out to a voice-mail system, would cause the text to be translated using a text-to-speech engine as the message is moved through the voice-mail system's connector. The translators can be isolated as individual components of the software tool in order to provide functionality for multiple connectors.

### BRIEF DESCRIPTION OF THE DRAWINGS

FIG. 1 illustrates an overview of the architecture of the present invention.

FIGS. 2-3 illustrate an example of the present invention.

### DETAILED DESCRIPTION OF THE INVENTION

The connector components and core logic engine of the software tool of the present invention enable synchronization between virtually any messaging systems that support a network-based connection or any connection method specific to a messaging system that the present invention will interface with. They are used to synchronize messages between two e-mail systems, two voice-mail systems, between a voice-mail and e-mail system, or even between file systems and e-mail/voice-mail systems. They can be used to synchronize any message system in any format.

The software tool can be written for use on various operating systems including, but not limited to, Unix, Linux, Windows NT/2000/XP, and a network “appliance” box. It is designed to be run in the background, transparent to the end users. Administration is accomplished through a web interface, a console interface and/or by modifying initialization files. Administrators are able to define which systems are being synchronized, what connectors are used, and which mailboxes/users/messages are synchronized. Various other system specific options are also configurable including, but not limited to, size, frequency, number of messages, resource utilization and time of day/week/month/year.

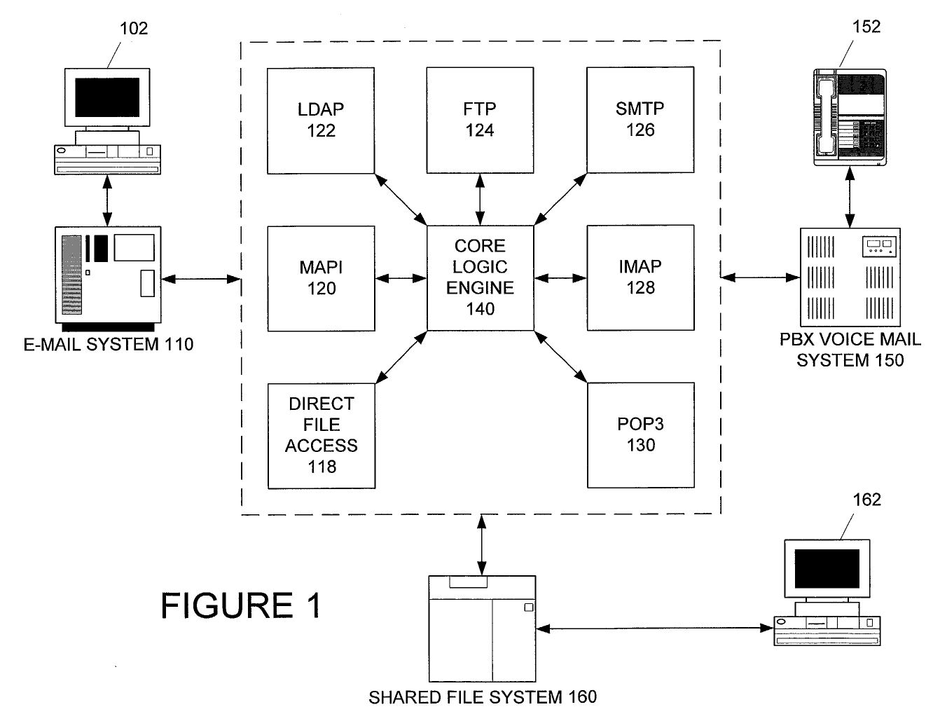

An embodiment of the present invention is illustrated in FIG. 1. The software tool 100 of the present invention is managed by an administrator and resides on a network enabled system or appliance, including being located on a separate server or appliance or being located on the e-mail system 110 server, the shared file system 160 server, or the PBX voice mail system 150 server. A first messaging system, such as an e-mail system 110, is connected to both client computers 102 and the network. A second messaging system, such as a PBX voice mail system 150, is connected to both telephones 152 and the network. A shared file system 160 can be connected to the network. Messages/files can be stored on the system 160 and synchronized with the e-mail and voice-mail systems 110 and 150. The shared file system 160 can also be an additional messaging system used with client computers 162 connected to the network. Although shown as separate, it is also anticipated that multiple functions can be combined into a single server and, conversely, that multiple servers may be used for single functions.

The software tool comprises a core logic engine 140 and a set of connectors for various messaging systems, such as Direct File Access connector 118, MAPI connector 120, LDAP connector 122, FTP connector 124, SMTP connector 126, IMAP connector 128, and POP3 connector 130. These connectors not only allow interfacing to almost any industry standard messaging system, but they also interact with the core logic engine 140 to perform any and all translations necessary to move messages between systems.

The core logic engine 140 is therefore able to accept lists of messages from any messaging system, based on the appropriate connector, and correlate changes to the messages based on definable parameters (such as: size, date, type, status). The core logic engine can then interact with the connectors to replicate and synchronize the messages between all of the messaging systems so that they contain identical content using the most recent version so that any of the messaging systems can be accessed and the exact same data can be independently accessed and modified. The logic functions are optimized to eliminate copying of unchanged messages. The software is run periodically in a “poll based” method to maintain full synchronization between messaging systems. A typical poll period might be every five minutes but can be set for any interval.

A good example to demonstrate application of the present invention is the following situation: a 3Com® NBX® Telephone System is installed on the network at a company. A Microsoft® Exchange Mail system is also installed on the network at the same company. The 3Com NBX supports data access via both FTP and IMAP. The Exchange System supports access via IMAP, POP3, FTP, MAPI, and Direct File Access. The software tool of the present invention can connect to the 3Com NBX and the Exchange System and synchronize the voice mails on the 3Com NBX with each user's personal mailbox on the Exchange System.

The end result: When a voice-message is left on the User A's phone via the 3Com NBX system, the software tool of the present invention replicates that voice message into User A's personal Exchange Mailbox as an industry standard “wave” file. User A can then listen to that message through their telephone or through their e-mail client, thereby enabling them to check e-mails and voice-mails from one place anywhere in the world. They can then use their e-mail client to forward their voice-message to User B's Exchange Mailbox. The software tool then replicates the voice-mail from User B's personal mailbox to their personal voice-mail box on the 3Com NBX phone system. User B can then retrieve the forwarded voice-mail through either the e-mail client or their phone.

Furthermore, User A can type an e-mail and send it to User B's personal Exchange Mailbox. The software tool of the present invention will then replicate that text message to User B's personal voice-mail box on the 3Com NBX, translating it from text-to-speech in the process. Now, User B can use their phone to listen to the e-mail sent by User A.

In a typical NBX-Microsoft Exchange embodiment, the logic employed by the software tool will:

1. Check if a reference file exists

a) if not: new box routine

b) if yes: go to 2

2. Download list from both boxes

3. Compare each list to reference file for delta's

4. Compare delta's and generate operations

5. Perform operations on each box

6. End

The new box routine would:

1. Check for existence of sub-folders

2. Download list from both boxes

3. Compare lists for delta's and generate operations

4. Perform operations on each box

5. End

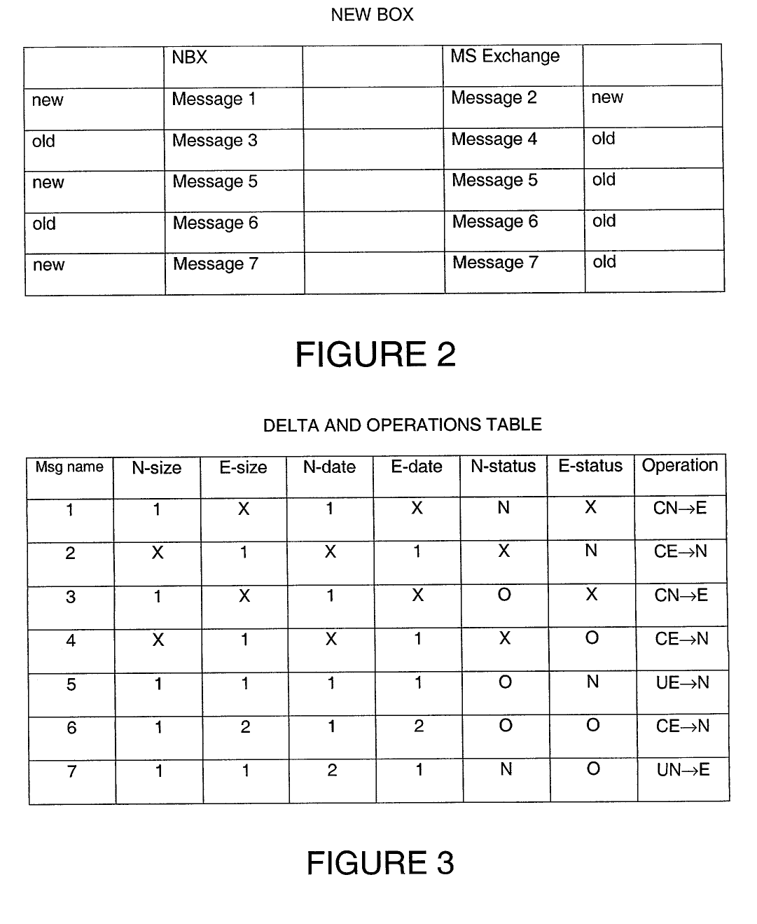

In reference to FIGS. 2-3, the logic functions that are listed here take place if the software tool encounters a new voice mail and e-mail box that it has never encountered before. The first thing listed here is an NBX system as the voice mail system and an Exchange system as the mail system. The messages are listed as message 1-7 and the columns describe what the messages are, their status and what operation is performed.

The first column lists message 1-7 to describe the name of the message. The second column lists the size of the message as it exists NBX voice mail system, so it uses a “1” or “2” to indicate its size relative to the Exchange system. The second column is the size of the messages as they exist on the Exchange system, so if the NBX system had a small message compared to the same message name on the Exchange system, then the NBX would have a “1” and the Exchange system would have a “2” and “X” is used to indicate that the field is not applicable, that the message does not exist, or that value is not considered. The third column lists the time and date stamp on the NBX system to indicate when it was created or last modified. The fourth column lists the same value for the Exchange mail system and again an “X” is used to indicate that the message does not exist or that field is not considered. A “2” and a “1” indicate their newness relative to each other, so a “1” indicates a older message and a “2” indicates a more recent or newer message. The sixth and seventh columns are indicating the status of the message or the file on the two systems. The sixth column is for the NBX phone system. An “N” indicates a new message meaning an unread status. An “O” indicates an old message or a read status and an “X” indicates that the message does not exist or the field is not considered. The seventh column is the same values on the Exchange mail system, again indicating “N” for new, “O” for old and “X” for not applicable. The last and final column is the eighth column that indicates operation that will then be performed on the message based on the values of those messages.

A “C” is used to indicate that the message is copied and that would be the first letter in the notation or a “U” can be used in place of the “C” and the “U” indicates that the message status is updated, so if the size and the name are all the same but the message has changed from a new to an old message, then the status would be updated. The second notation in that operation indicates the source system using “N” for NBX or “E” for Exchange. The third notation is just an arrow indicating that it is moving to the final system. And that is the fourth notation using “E” for Exchange and “N” for NBX, which indicates the destination system for the operation to perform.

The logic described herein could be performed after it has been imported through a connector. The source code can be written in any suitable language, such as C++ or standard shell scripts or Visual Basic, so as to acquire the values of the messages and perform the operations.

While the invention has been described in detail herein in accord with certain preferred embodiments thereof, modifications and changes therein may be effected by those skilled in the art. Accordingly, it is intended by the appended claims to cover all such modifications and changes as fall within the scope of the invention.

What is claimed is:

1. A unified messaging system, comprising:
a network;
a first messaging system connected to the network;
at least one additional messaging system connected to the network;
a network-connected device employing a software tool to integrate said messaging systems, said software tool comprising:
means to accept lists of messages from each messaging system,
means to correlate changes to said messages based on definable parameters selected from the group consisting of: size, date, type, and status, and
means to replicate and synchronize said messages between all of the messaging systems so that they contain identical content.

2. The unified messaging system of claim [c1], further comprising a shared file system connected to said network.

3. The unified messaging system of claim [c2], wherein said shared file system includes means for storing flat files.

4. The unified messaging system of claim [c3], wherein said shared file system comprises an additional messaging system.

5. The unified messaging system of claim [c1], wherein said means to accept accepts messages selected from the group consisting of voice, e-mail, fax, SMS, IM, and pager.

6. The unified messaging system of claim [cl], wherein said means to replicate reproduces message content in an appropriate standard format for each messaging system.

7. A method of unifying messaging on a network, comprising:
accepting lists of messages from a plurality of messaging systems connected to said network,
correlating changes to said messages based on definable parameters selected from the group consisting of: size, date, type, and status, and
replicating and synchronizing said messages between all of the messaging systems so that they contain identical content.

8. A method of unifying messaging of claim [c7], further comprising storing flat files on a shared file system connected to said network.

9. A method of unifying messaging of claim [c8], further comprising employing said shared file system as an additional messaging system.

10. A method of unifying messaging of claim [c7], wherein messages accepted in forms selected from the group consisting of voice, e-mail, fax, SMS, IM, and pager.

11. A method of unifying messaging of claim [c7], wherein said replicating step reproduces message content in an appropriate standard format for each messaging system.
